(19) United States
(12) Patent Application Publication
(10) Pub. No.: US 2026/0044245 A1
(43) Pub. Date: Feb. 12, 2026

(54) MULTIMODAL INPUT SWITCHER

(71) Applicant: Google LLC, Mountain View, CA (US)

(72) Inventors: Simon Edward Roberts, London (GB); Carsten Hinz, Mountain View, CA (US); Andreas Thor Agvard, Stockholm (SE)

(21) Appl. No.: 19/284,144

(22) Filed: Jul. 29, 2025

Related U.S. Application Data
(60) Provisional application No. 63/682,002, filed on Aug. 12, 2024.

(51) Int. Cl. G06F 3/04817; G06F 3/04883; G06T 13/80

(52) U.S. Cl. CPC G06F 3/04817; G06F 3/04883; G06T 13/80

(57) ABSTRACT

Aspects of this disclosure are directed to techniques for outputting, for display at a display device, data for a zero state graphical user interface; receiving an indication of a first user input provided at a location of the zero state graphical user interface; outputting, for display at the display device, data for a first graphical user interface, the first graphical user interface including a plurality of icons; receiving an indication of a second user input provided at a location of the first graphical user interface associated with an icon from the plurality of icons; outputting, for display at the display device, data for a second graphical user interface, the second graphical user interface including a visual indication of an action associated with the icon; and responsive to the second user input terminating at a location of the second graphical user interface associated with the icon, initiating the action.

This application claims benefit of U.S. Provisional Application No. 63/682,002 filed Aug. 12, 2024, the entire content of which is hereby incorporated by reference.

### BACKGROUND

A computing device may include a display device that displays content from one or more applications executing at the computing device, such as textual or graphical content. A user may interact with a graphical user interface using a presence-sensitive screen (e.g., touchscreen) of the computing device to enter and/or switch between different input states, such as a text box, camera interface, voice recording interface, or the like.

### SUMMARY

In general, aspects of this disclosure are directed to techniques for switching between various multimodal input states (also referred to herein as “multimodal input actions”). A computing device may receive user inputs at a first user interface (e.g., a graphical user interface output during operation of the computing device such as a home screen interface, a lock screen interface, an interface associated with a software application, etc.) displayed at a display device to switch between various multimodal input actions, such as inputting a screen selection, inputting text, inputting speech, camera inputs, or any combinations thereof. The computing device may output, based on user inputs at the first user interface, a second user interface as a multimodal input switcher that includes icons mapped to multimodal input actions. The computing device may output, based on user inputs at the second user interface, a third user interface that previews a multimodal input action by including a visual indication that suggests or is indicative of the multimodal input action. The computing device may initiate, based on user inputs at the third user interface, a multimodal input action. The computing device may support seamless switching between multimodal input actions based on a single user input (e.g., a user input including a combination of press actions, swipe actions, etc.) detected to be at particular locations of each of the user interfaces.

In one example, the disclosure is directed to a method that includes outputting, by one or more processors and for display at a display device, data for a zero state graphical user interface. The method may further include receiving, by the one or more processors, an indication of a first user input provided at a location of the zero state graphical user interface. The method may further include responsive to receiving the indication of the first user input, outputting, by the one or more processors and for display at the display device, data for a first graphical user interface, the first graphical user interface including a plurality of icons. The method may further include receiving, by the one or more processors, an indication of a second user input provided at a location of the first graphical user interface associated with an icon from the plurality of icons. The method may further include responsive to receiving the indication of the second user input, outputting, by the one or more processors and for display at the display device, data for a second graphical user interface, the second graphical user interface including a visual indication of an action associated with the icon. The method may further include responsive to the second user input terminating at a location of the second graphical user interface associated with the icon, initiating, by the one or more processors, the action associated with the icon.

In another example, the disclosure is directed to a computing device. The computing device includes a display device; one or more processors; and a memory that stores instructions that, when executed by the one or more processors, cause the one or more processors to: output, for display at the display device, data for a zero state graphical user interface; receive an indication of a first user input provided at a location of the zero state graphical user interface; responsive to receiving the indication of the first user input, output, for display at the display device, data for a first graphical user interface, the first graphical user interface including a plurality of icons; receive an indication of a second user input provided at a location of the first graphical user interface associated with an icon from the plurality of icons; responsive to receiving the indication of the second user input, output, for display at the display device, data for a second graphical user interface, the second graphical user interface including a visual indication of an action associated with the icon; and responsive to the second user input terminating at a location of the second graphical user interface associated with the icon, initiate the action associated with the icon.

In another example, the disclosure is directed to a non-transitory computer-readable storage medium storing instructions that, when executed, cause one or more processors of a computing device to: output, for display at a display device, data for a zero state graphical user interface; receive an indication of a first user input provided at a location of the zero state graphical user interface; responsive to receiving the indication of the first user input, output, for display at the display device, data for a first graphical user interface, the first graphical user interface including a plurality of icons; receive an indication of a second user input provided at a location of the first graphical user interface associated with an icon from the plurality of icons; responsive to receiving the indication of the second user input, output, for display at the display device, data for a second graphical user interface, the second graphical user interface including a visual indication of an action associated with the icon; and responsive to the second user input terminating at a location of the second graphical user interface associated with the icon, initiate the action associated with the icon.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device for switching between initiations of actions associated with multimodal inputs, in accordance with one or more aspects of the present disclosure.

FIG. 2 is a block diagram illustrating an example computing device for prompting multimodal inputs based on user inputs, in accordance with one or more aspects of the present disclosure.

FIG. 3 is a conceptual diagram illustrating an example computing device configured switch between example graphical user interfaces, in accordance with aspects of this disclosure.

FIG. 4A-4C are conceptual diagrams illustrating an example computing device configured to initiate actions, in accordance with aspects of this disclosure.

FIG. 5 is a conceptual diagram illustrating an example computing device with example graphical user interface locations, in accordance with aspects of this disclosure.

FIG. 6 is a flowchart illustrating example operations for switching between initiations of actions associated with multimodal inputs, in accordance with one or more aspects of the present disclosure.

Like reference characters denote like elements throughout the text and figures.

### DETAILED DESCRIPTION

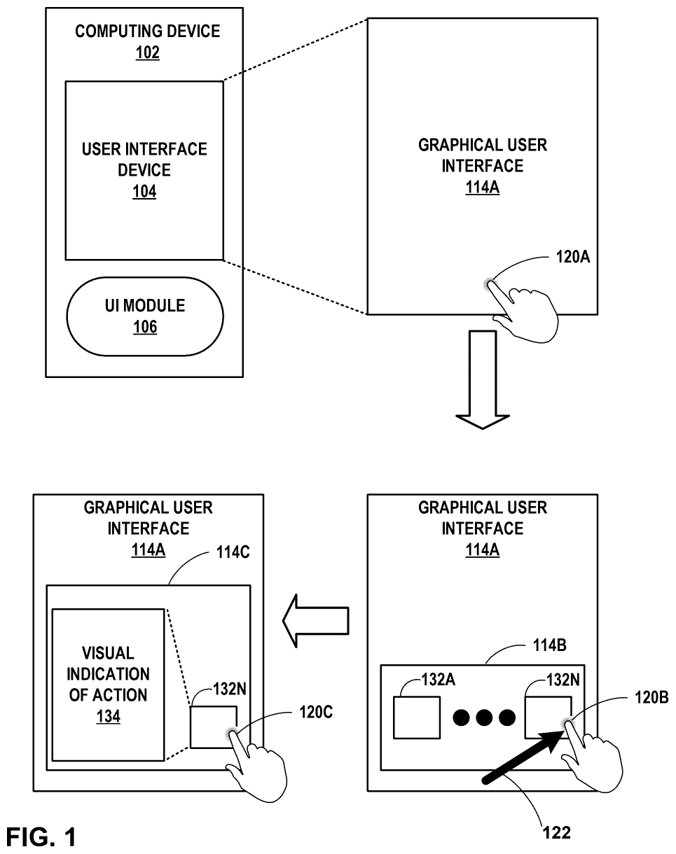

FIG. 1 is a conceptual diagram illustrating example computing device 102 for switching between initiations of actions associated with multimodal inputs, in accordance with one or more aspects of the present disclosure. In the example of FIG. 1, computing device 102 is a mobile computing device (e.g., a mobile phone). However, in other examples, computing device 102 may be a tablet computer, a laptop computer, a desktop computer, a gaming system, a media player, an e-book reader, a television platform, an automobile navigation system, a virtual reality device, an augmented reality device, a wearable computing device (e.g., a computerized watch, computerized eyewear such as AI glasses, a computerized glove, a computerized ring, etc.), or any other type of mobile or non-mobile computing device.

Computing device 102 includes a user interface device (UID) 104 and user interface (UI) module 106. UID 104 of computing device 102 may function as an input device for computing device 102 and as an output device for computing device 102. UID 104 may be implemented using various technologies. For instance, UID 104 may function as an input device using a presence-sensitive input screen, such as a resistive touchscreen, a surface acoustic wave touchscreen, a capacitive touchscreen, a projective capacitive touchscreen, a pressure sensitive screen, an acoustic pulse recognition touchscreen, or another presence-sensitive display technology. UID 104 may function as an output (e.g., display) device using any one or more display devices, such as a liquid crystal display (LCD), dot matrix display, light emitting diode (LED) display, microLED, miniLED, organic light-emitting diode (OLED) display, e-ink, or similar monochrome or color display capable of outputting visible information to a user of computing device 102.

UID 104 of computing device 102 may include a presence-sensitive display that may receive tactile input from a user of computing device 102. UID 104 may receive indications of tactile input by detecting one or more gestures from a user of computing device 102 (e.g., the user touching or pointing to one or more locations of UID 104 with a finger or a stylus pen). UID 104 may present output to a user, for instance at a presence-sensitive display. UID 104 may present the output as a graphical user interface (e.g., any one of graphical user interfaces 114), which may be associated with functionality provided by computing device 102. For example, UID 104 may present various user interfaces (e.g., graphical user interfaces associated with a lock screen graphical user interfaces, home screen graphical user interfaces, software application graphical user interfaces, camera input graphical user interfaces, input text box graphical user interfaces, input audio graphical user interfaces, etc.) of components of a computing platform, operating system, applications, or services executing at or accessible by computing device 102. A user may interact with a respective user interface to cause computing device 102 to perform operations relating to a function.

UI module 106 of computing device 102 may manage user interactions with UID 104 and other components of computing device 102. In other words, UI module 106 may act as an intermediary between various components of computing device 102 to make determinations based on indications of user inputs detected by UID 104 and generate output at UID 104 in response to the user inputs. UI module 106 may receive instructions from an application, service, platform, or other module of computing device 102 to cause UID 104 to output graphical user interfaces, such as graphical user interfaces 114. Graphical user interfaces (GUIs) 114A, 114B, and 114C (collectively referred to herein as “GUIs 114”) may include data output, by UI module 106 via UID 104, according to instructions stored at an operating system of computing device 102, a software application of computing device 102, or the like.

UI module 106, according to the techniques described herein, may manage multimodal inputs received by user operating computing device 102 by, for example, initiating an action of prompting a user operating computing device 102 to input particular multimodal data (e.g., text, voice, images, etc.) based on multimodal input actions associated with locations 120 and/or path 122 at graphical user interfaces 114. UI module 106 may manage indications user inputs associated with locations 120 and/or path 122 at graphical user interfaces 114 (e.g., user inputs interacting with the user interface presented at UID 104) and update graphical user interfaces output by UID 104 in response to processing the indications user inputs associated with locations 120 and/or path 122 at graphical user interfaces 114.

In accordance with the techniques described herein, computing device 102 may initiate an action based on receiving indications of user inputs at locations 120 of graphical user interfaces 114. UID 104 may display GUI 114A that is associated with a zero state graphical user interface. A zero state graphical user interface may include data for a user interface that is displayed via UID 104 during operation of computing device 102 at a point in time prior to receiving the indication of the first user input as described herein. GUI 114A may include visual data, displayed via UID 104, associated with a lock screen, a home screen, a software application user interface, or other graphical user interface displayed by UID 104 during operation of computing device 102. For example, UI module 106 may receive instructions from an operating system of computing device 102 to output graphical user interface 114A to include visual data associated with a home screen.

Computing device 102 may receive an indication of a first user input provided at location 120A of GUI 114A. UID 104 may receive indications of user inputs such as tactile inputs (e.g., long-press tactile input, swipe-up tactile input, press tactile input, etc.), motion inputs (e.g., eye movements, hand or finger air gestures, or other inputs associated with augmented reality or virtual reality environments), or other types of inputs that may be detected by UID 104. In the example of FIG. 1, UID 104 may receive an indication of a first user input at location 120A that is located near the bottom of GUI 114A. In some examples, location 120A of GUI 114A may be included in an icon zone or region of GUI 114A that is included in other graphical user interfaces output by UI module 106. For example, location 120A may be located in a navigation bar region that persists throughout graphical user interfaces output by UI module 106 according to instructions from an operating system of computing device 102.

Responsive to receiving the indication of the user input provided at location 120A of GUI 114A, computing device 102 may display, via UID 104, data for GUI 114B. GUI 114B may include visual data, displayed via UID 104, associated with a switching state graphical user interface that includes icons 132A-132N (collectively referred to herein as “icons 132”). Icons 132 may include a graphical element associated with actions that may be initiated by UI module 106. In some instances, icons 132 may include customizable graphical elements that a user operating computing device 102 may assign to different actions (e.g., different prompting of multimodal input data) that UI module 106 may initiate. In some examples, icons 132 may correspond to one or more generate modes (e.g., search functionality, translate functionality, etc.), one or more search modes (e.g., text search, audio search, image search, etc.), and/or other modes associated with multi-modal inputs. In the example of FIG. 1, UI module 106 may output GUI 114B as a user interface that overlays or is displayed on top of GUI 114A.

Computing device 102 may receive an indication of a second user input provided at location 120B of GUI 114B. Location 120B may include a region of GUI 114B associated with an icon of icons 132. In the example of FIG. 1, UID 104 may receive the indication of the second user input provided at location 120B associated with icon 132N. In some examples, UI module 106 may register the second user input provided at location 120B responsive to the first user input and the second user input being a single, continuous user input along path 122. That is, UI module 106 may proceed to output GUI 114C responsive to the first user input and the second user input being included in a continuous, gestural input. In this way, UI module 106 may quickly allow a user to preview multimodal input states with a single, continuous user input, thereby reducing computational resources (e.g., processing cycles, memory usage, power consumption, etc.) associated with switching between multimodal input states via multiple user inputs that may result in outputting graphical user interfaces that a user may not want to interact with. In the example of FIG. 1, UI module 106 may replace GUI 114B with GUI 114C responsive to receiving the second user input at location 120B of GUI 114B. UI module 106 may output GUI 114C as a user interface that overlays or is displayed on top of GUI 114A.

Responsive to receiving the indication of the second user input provided at location 120B of GUI 114B, computing device 102 may display, via UID 104, data for GUI 114C. GUI 114C may include visual data, displayed via UID 104, associated with an input state graphical user interface that includes a selected icon of icons 132 (e.g., icon 132N) and visual indication of action 134 associated with the selected icon of icons 132. Visual indication of action 134 may include one or more graphical elements that indicate, suggest, or otherwise preview functionality of a multimodal input that computing device 102 may prompt a user to provide as part of an action initiated by UI module 106. For example, in instances where icon 132N is associated with an action of prompting a user to input image data included in GUI 114A, visual indication of action 134 may include graphical elements of identified image objects of GUI 114A that a user operating computing device 102 may select as the input image data. In another example, in instances where icon 132N is associated with an action of prompting a user to input image or video data using a camera and/or microphone of computing device 102, visual indication of action 134 may include an animation of a graphical element of a preview window of image data captured using the camera of computing device 102. In this way, UI module 106 may avoid unnecessarily consuming computational resources (e.g., processing cycles, memory usage, power consumption, etc.) by allowing a user to preview a multimodal input state without executing processes of the multimodal input state, such that a user may choose to cancel entering the previewed multimodal input state (e.g., after viewing visual indication of action 134) and avoid unnecessarily consuming computational resources associated with executing the multimodal input state.

Responsive to the second user input terminating at a location at or near location 120C of GUI 114C, computing device 102 may initiate an action associated with the selected icon of icons 132. Computing device 102 may initiate actions associated with various multimodal prompts that request a user operating computing device 102 to input multimodal data based on a selected icon of icons 132. In one example, computing device 102 may initiate an action such as recognizing data objects displayed in GUI 114A and prompt a user to input a recognized data object by selecting the data object via UID 104. Data objects displayed in GUI 114A may include images, text, files, or other multimodal data displayed in GUI 114A. Computing device 102 may recognize data objects in GUI 114A (e.g., a zero state graphical user interface displaying data for a software application, a webpage, etc.) using pre-trained machine learning models trained for real-time object detection and recognition. In some instances, computing device 102 may recognize data objects in GUI 114A by identifying elements included in data for GUI 114A. For example, computing device 102 may analyze hierarchical data for GUI 114A to extract locations in GUI 114A in which a data object is located. Computing device 102 may initiate an action of rendering a modified version of GUI 114A to highlight (e.g., bold, add shading around, etc.) identified data objects of GUI 114A at the locations of GUI 114A in which the data objects are located. Computing device 102 may output the modified version of GUI 114A. Computing device 102 may detect an event of a user operating computing device 102 selecting a highlighted data object. Computing device 102 may process the input event by, for example, conducting a search associated with the selected data object (e.g., input the highlighted data object into a search engine).

In another example, computing device 102 may initiate an action such as prompting a user operating computing device 102 to input speech or other audio. For example, responsive to a user input terminating at location 120C of GUI 114C, computing device 102 may activate a microphone or other audio input device for a period of time. Computing device 102 may receive input speech or audio data via the microphone or other audio input device. Computing device 102 may activate the microphone or other audio input device for a period of time in which computing device 102 is detecting speech (e.g., a period of time in which input audio is above a certain decibel level, within a certain frequency, etc.). Computing device 102 may process input audio by, for example, conducting a search associated with the input audio (e.g., input the audio, or a transcription thereof, into a search engine), generating a response based on the input audio (e.g., prompting a generative machine learning model with the input audio to generate a response), storing the input audio data at a storage device, or the like.

In another example, computing device 102 may initiate an action such as prompting a user to input text. For example, responsive to a user input terminating at location 120C of GUI 114C, computing device 102 may output data for an input text box prompting a user to input text via UID 104. Computing device 102 may output data for the input text box as a graphical user interface that replaces GUI 114C. Computing device 102 may output data for the input text box as a graphical user interface that overlays or is displayed on top of GUI 114A. Computing device 102 may receive input text as a string data structure computing device 102 generates based on user inputs at an electronic keyboard that may be output as part of the graphical user interface including the input text box. Computing device 102 may process input text by, for example, conducting a search associated with the input text (e.g., input the text into a search engine), generating a response based on the input text (e.g., prompting a generative machine learning model with the input text to generate a response), storing data for the input text at a storage device, or the like.

In another example, computing device 102 may initiate an action such as outputting data for a graphical user interface associated with camera functionality (e.g., a camera interface, camera viewfinder, etc.) to prompt a user to input an image or video using a camera of computing device 102. For example, responsive to a user input terminating at location 120C of GUI 114C, computing device 102 may output data for a camera interface that prompts a user to record an image or a video using a camera of computing device 102. Computing device 102 may store the image or the video captured using the camera at a storage device. In some instances, computing device 102 may process the image or the video captured using the camera by, for example, recognizing data objects within the image or the video, conducting a search based on the image or the video (e.g., input the image or the video into a search engine), generating a response based on the image or the video (e.g., prompting a generative machine learning model with the image or the video to generate a response), or the like.

In another example, computing device 102 may initiate an action such as outputting data for a graphical user interface associated with a software application to prompt a user to input multimodal data via the graphical user interface associated with the software application. For example, responsive to a user input terminating at location 120C of GUI 114C, computing device 102 may output data for a graphical user interface associated with a software application, such as a web browser application, a messaging application, a video streaming application, a social media application, a search application, a translation application, a general mode application, or other software application associated with a graphical user interface that prompts a user to input multimodal data (e.g., a user interface associated with inputting search or translation text, images, audio, and/or combinations thereof). Computing device 102 may output data for a graphical user interface associated with a software application by, for example, executing data for the software application.

Computing device 102 may initiate a particular action based on an icon of icons 132 that has been selected via interactions with GUI 114B and GUI 114C. Icons of icons 132 may map to different actions. For example, icon 132A may map to an action of recognizing data objects of GUI 114A and prompting a user to select a data object. Icon 132B may map to an action of prompting a user to input speech or other audio. Icon 132C may map to an action of prompting a user to input text. Icon 132D may map to an action of outputting data for a graphical user interface associated with camera functionality. Icon 132N may map to an action of outputting data for a graphical user interface associated with a software application (e.g., browser application, messaging application, search application, translation application, etc.). Computing device 102 may store mappings of icons 132 to actions. Based on a user input terminating at a location associated with an icon (e.g., location 120C associated with icon 132N of GUI 114C), computing device 102 may access the mappings of icons 132 to actions and initiate the action mapped to the icon. Computing device 102 may initiate an action—based on an icon of icons 132 that has been selected via interactions with GUI 114B and GUI 114C—that includes prompting a user to input any combination of multimodal inputs (e.g., initiate camera and microphone functionality to a prompt a user to input video and audio data).

The techniques described herein may provide one or more technical advantages that realize one or more practical applications. For example, some computing devices may need multiple user inputs in order to switch between prompts for different multimodal data inputs, thereby consuming computational resources (e.g., processing cycles, memory storage, power consumption, etc.) of the computing device associated with detecting events of user inputs to switch between various multimodal input actions. By providing a user options to select prompts for multimodal inputs in a zero state graphical user interface (e.g., GUI 114A), computing device 102 may reduce the consumption of computational resources of computing device 102 associated with detecting events of user inputs to switch between various multimodal input actions. Rather than having to search data of computing device 102 (e.g., via a search box) to initiate actions associated with multimodal inputs, computing device 102 may improve discoverability by allowing a user to quickly and efficiently switch between the actions associated with multimodal inputs via a switching state graphical user interface (e.g., GUI 114B) that may be displayed any time during operation of computing device 102, irrespective of a zero state graphical user interface being output by computing device (e.g., GUI 114A). Computing device 102 may also preview multimodal input actions by outputting visual indication of action 134, which may avoid unnecessarily consuming computational resources in instances where a user operating computing device 102 does not want to execute a particular multimodal input action associated with visual indication of action 134. In other words, by outputting a preview of a multimodal input action, computing device 102 may allow the opportunity for a user to quickly view available multimodal input actions without having to execute the multimodal input actions.

In some examples, in instances where the first user input and the second user input are part of a single, continuous user input, the computing device may quickly and efficiently initiate an action based on a single, gestural user input. In this way, computing device 102 may quickly switch between various multimodal input actions by consuming fewer computational resources (e.g., processing cycles, memory storage, power consumption) compared to other techniques for switching between multimodal input actions. Computing device 102 may improve a user's experience interacting with user interfaces output by computing device 102 by providing fast, easy access to different multimodal input modes without having a user provide multiple user inputs to switch between the different multimodal inputs.

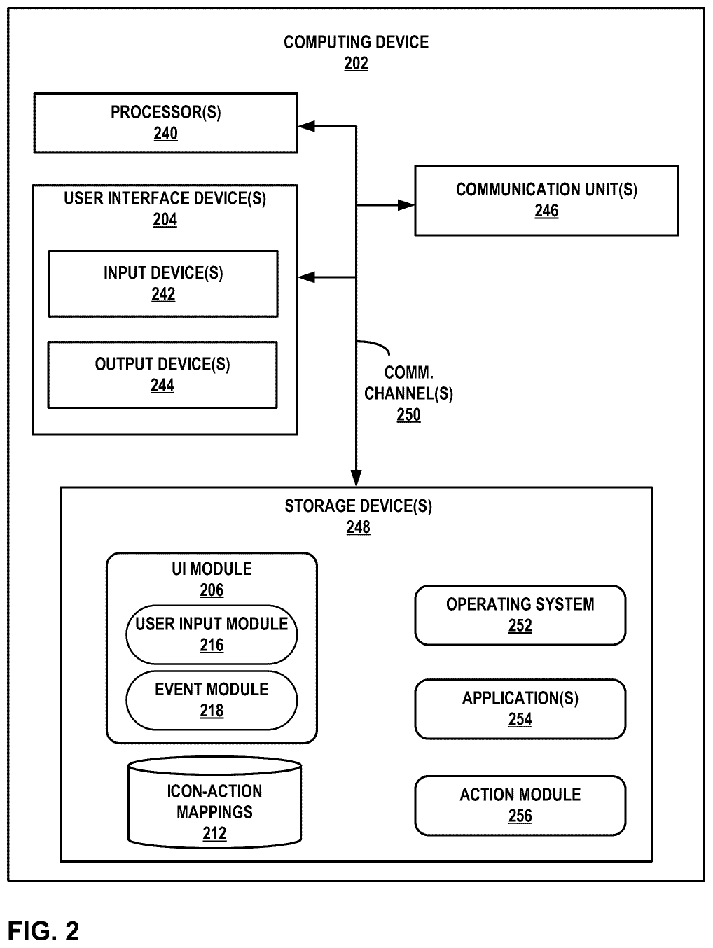

FIG. 2 is a block diagram illustrating an example computing device for prompting multimodal inputs based on user inputs, in accordance with one or more aspects of the present disclosure. Computing device 202, one or more user interface devices (UID) 204, and UI module 206 of FIG. 2 may be example or alternative implementations of computing device 102, user interface device 104, and UI module 106 of FIG. 1, respectively. Computing device 202, in the example of FIG. 2, may include processors 240, communication units 246, UID 204, storage devices 248, communication channels 250. Communication channels 250 may interconnect each of components 240, 204, 246, and/or 248 for inter-component communication (physically, communicatively, and/or operatively). In some examples, communication channels 250 may include a system bus, a network connection, one or more inter-process communication data structures, or any other components for communicating data between hardware and/or software.

Computing device 202 may communicate with other computing devices or computing systems with one or more communication units 246. One or more communication units 246 may communicate with external devices by transmitting and/or receiving data. For example, computing device 202 may use communication units 246 to transmit and/or receive radio signals and radio networks such as a cellular radio network. In some examples, communication units 246 may transmit and/or receive satellite signals on a satellite network such as a Global Positioning System (GPS) network. Examples of communication units 246 include a network interface card (e.g., such as an Ethernet card), an optical transceiver, a radio frequency transceiver, a GPS receiver, or any other type of device that can send and/or receive information. Other examples of communication units 246 include Bluetooth®, GPS, 3G, 4G, and Wi-Fi® radios found in mobile devices as well as Universal Serial Bus (USB) controllers and the like.

UID 204 may include one or more input devices 242 and one or more output devices 244. Input devices 242 of UID 204 may receive input. Examples of inputs are tactile, audio, video, motion, and/or environmental inputs. Input devices 242, in one example, may include a presence-sensitive display, a virtual reality display, a wearable device display, heads-up display, a fingerprint sensor, touch-sensitive screen, mouse, keyboard, voice responsive system, video camera, microphone or any other type of device for detecting input from a human or machine. Input devices 242 may additionally or alternatively include one or more sensors. For example, input devices 242 may include sensors configured as an input component that obtains physical positions, movement, location information, physiological information, or other environmental information associated with computing device 202. For instance, sensors may include one or more location sensors (e.g., GNSS components, Wi-Fi components, cellular components), one or more temperature sensors, one or more motion sensors (e.g., multi-axial accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

Output devices 244 of UID 204 may generate one or more outputs. Examples of outputs are tactile, audio, video, or the like. Output devices 244, in one example, includes a presence-sensitive display, virtual reality display, wearable device display, heads-up display, sound card, video graphics adapter card, speaker, liquid crystal display (LCD), or any other type of device for generating output to a human or machine. Although illustrated as separate components, one or more of input devices 242 and one or more of output devices 244 may include the same device (e.g., a presence-sensitive display).

One or more processors 240 may implement functionality and/or execute instructions with computing device 202. For example, processors 240 of computing device 202 may receive and execute instructions stored by one or more storage devices 248 that provide the functionality of UI module 206, icon-action mapping 212, operating system 252, one or more software applications 254, and/or action module 256, for example. These instructions executed by processors 240 may cause computing device 202 to store and/or modify information, within storage devices 248 during program execution.

One or more storage devices 248 within computing device 202 may store information for processing during operation of UI module 206, icon-action mapping 212, operating system 252, one or more software applications 254, and/or action module 256. In some examples, storage devices 248 include a temporary memory, meaning that a primary purpose of storage devices 248 is not long-term storage. Storage devices 248 of computing device 202 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art.

Storage devices 248, in some examples, also include one or more computer-readable storage media. Storage devices 248 may be configured to store larger amounts of information than volatile memory. Storage devices 248 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage devices 248 may store program instructions and/or data associated with UI module 206, icon-action mapping 212, operating system 252, one or more software applications 254, and/or action module 256.

One or more software applications 254 may include functionality to perform any variety of operations on computing device 202. For instance, applications 254 may include a word processor, a text application, a web browser, a messaging application, a social media application, a gaming application, a multimedia player, a calendar application, an operating system, a distributed computing application, a graphic design application, a video editing application, a web development application, or any other application. Applications 254 may include software applications that, when executed, may generate data for a graphical user interface that prompts a user operating computing device 202 to input one or more types of multimodal data. For example, one of applications 254 may include a camera application configured to prompt a user to input image or video data using a camera and/or microphone of input devices 242. The camera application of applications 254 may include functionality of recognizing data objects of an image or video captured using input devices 242. For example, the camera application of applications 254 may apply machine learning techniques to identify objects captured using a camera of input devices 242. The camera application of applications 254 may prompt a user to select an identified object of image data captured using the camera. The camera application of applications 254 may use the selected object as a multimodal input to perform various functions, such as performing a search based on the selected object, saving the selected object, generating a response by inputting the selected object as a prompt for a generative machine learning model, or the like.

In another example, one of applications 254 may include a search engine application. For example, the search engine application of applications 254 may prompt a user to input any type of multimodal data (e.g., image, video, audio, text, etc.). The search engine application of applications 254 may perform a search based on the input data to generate search results. For instance, the search engine application of applications 254 may search the Internet based on the input data to generate and output search results associated with the input data. In some examples, the search engine application of applications 254 may implement machine learning techniques to automatically recognize data objects of input data (e.g., objects of an input image). The search engine application of applications 254 may perform a search and output search results based on one or more recognized data objects of the input data.

Operating system (OS) 252 may control the operation of components of computing device 202. For example, OS 252 may facilitate the communication of modules 206, 254, and/or 256 with processors 240, UID 204, storage devices 248, and communication units 246. In some examples, OS 252 may manage interactions between software applications (e.g., applications 254) and a user of computing device 202. OS 252 may have a kernel that facilitates interactions with underlying hardware of computing device 202 and provides a fully formed application space capable of executing a wide variety of software applications having secure partitions in which each of the software applications executes to perform various operations. In some examples, UI module 206 may be considered a component of OS 252.

UI module 206, in the example of FIG. 2, may include user input module 216 and event module 218. User input module 216 may include software readable instructions for determining indications of user inputs. User input module 216 may determine indications of user inputs based on inputs received by input devices 242. For instance, user input module 216 may process data of a tactile input received by input devices 242 to determine an indication of the tactile input provided at a location of a graphical user interface (e.g., pixel coordinates associated with the graphical user interface). User input module 216 may generate a touch event based on the determined location of the graphical user interface where the tactile input was provided. User input module 216 may perform hit testing to identify which graphical user interface icon (e.g., user interface element, object, view, etc.) corresponds to the tactile input received by input devices 242. User input module 216 may dispatch the touch event and identified graphical user interface icon to event module 218. In some examples, user input module 216 may determine a location of a graphical user interface where a motion input was provided (e.g., eye movement, spatial motion detection, etc.). User input module 216 may dispatch a motion event associated with a location of a graphical user interface.

Event module 218 may include software readable instructions for handling events generated by user input module 216. For example, event module 218 may include a subscriber configured to register multiple listeners to various events generated by user input module 216. Event module 218 may implement a listener configured to retrieve data for a graphical user interface associated with an event generated by user input module 216. For example, user input module 216 may generate an event based on an indication of a user input provided at a location (e.g., location 120A of FIG. 1) of a zero state graphical user interface (e.g., GUI 114A of FIG. 1) associated with an invocation point (e.g., a virtual home button, a navigation handle, a search bar, or other graphical user interface element). Event module 218 may implement a listener configured to retrieve data for a switching state graphical user interface (e.g., GUI 114B of FIG. 1) responsive to receiving the event generated by user input module 216. Event module 218 may output the data for the switching state graphical user interface to output devices 244 for display.

In another example, user input module 216 may generate an event based on an indication of a user input provided at a location (e.g., location 120B of FIG. 1) of a switching state graphical user interface (e.g., GUI 114B of FIG. 1) associated with an icon of a plurality of icons (e.g., icons 132 of FIG. 1) displayed in the switching state graphical user interface. Event module 218 may implement a listener configured to retrieve data for an input state graphical user interface (e.g., GUI 114C of FIG. 1) responsive to receiving the event generated by user input module 216. Event module 218 may output the data for input state graphical user interface to output devices 244 for display.

In another example, user input module 216 may generate an event based on a user input terminating at a location (e.g., location 120C of FIG. 1) of an input state graphical user interface (e.g., GUI 114C of FIG. 1) associated with an icon (e.g., icon 132N of FIG. 1) displayed in the input graphical user interface. Event module 218 may implement a listener configured to retrieve data for an action mapped to the icon responsive to receiving the event generated by user input module 216. Event module 218 may initiate the action based on the retrieved data for the action. Event module 218 may retrieve data for the action from icon-action mappings 212. In some examples, event module 218 may forward events associated with a user input terminating at a location of an input state graphical user interface to action module 256.

Action module 256 may include software readable instructions for initiating actions based on events received from event module 218. For example, action module 256 may be configured to initiate an action based on an event associated with a user input terminating at a location of an input state graphical user interface generated by user input module 216. Action module 256 may determine an action to initiate based on an icon associated with the event and icon-action mappings 212. For example, user input module 216 may generate an event based on a user input terminating at a location associated with an icon included in an input state graphical user interface. User input module 216 may generate the event to include an indication of the icon. User input module 216 may send the event to action module 256. Action module 256 may query icon-action mappings 212 to retrieve data for initiating an action associated with the icon.

Icon-action mappings 212 may include configuration information specifying correlations of multimodal input actions to icons within a switching state graphical user interface (e.g., GUI 114B). In some examples, icon-action mappings 212 may include an index table data structure for retrieving data for actions initiated by event module 218 and/or action module 256. For example, icon-action mappings 212 may include key-value pairs where a key indicates an icon displayed in a switching state graphical user interface, and a value includes a reference to a location of storage devices 248 where data for a respective action is stored. In general, icon-action mappings 212 may include a data structure that maps data for initiating actions to respective icons (e.g., icons 132 of FIG. 1). In some examples, icon-action mappings 212 may include a predefined mapping of actions to icons. In some instances, icon-action mappings 212 may be configurable by a user operating computing device 202. For example, computing device 202 may output a user interface, via output devices 244, prompting a user to select icons to be included in a switching state graphical user interface and select actions to be mapped to the icons. Computing device 202 may receive, via input devices 242, user inputs of icon-action mappings. Computing device 202 may store the user inputs of icon-action mappings as icon-action mappings 212.

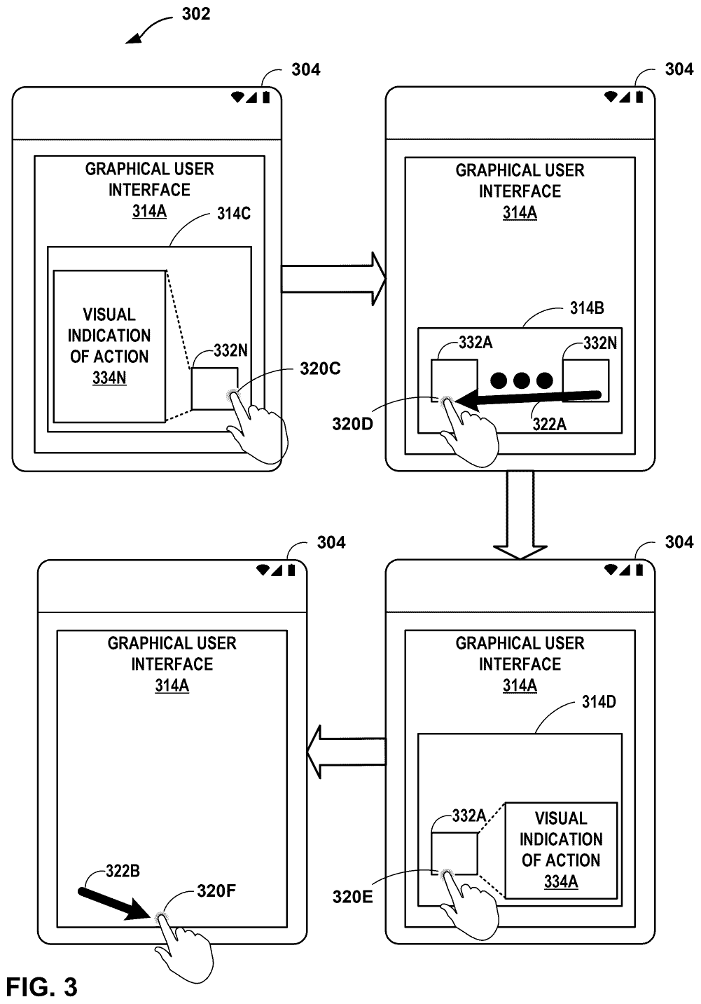

FIG. 3 is a conceptual diagram illustrating example computing device 302 configured switch between example graphical user interfaces 314, in accordance with aspects of this disclosure. Computing device 302, user interface device (UID) 304, graphical user interfaces 314A-314D (collectively referred to as “GUIs 314”), icons 332, visual indication of action 334N, and location 320C may be example or alternative implementations of computing device 102, UID 104, GUIs 114, icons 132, visual indication of action 134, and location 120C of FIG. 1, respectively.

In the example of FIG. 3, UID 304 may display data for GUI 314C associated with an input state graphical user interface. UID 304 may display GUI 314C along with GUI 314A, which is associated with a zero state graphical user interface. UID 304 may display GUI 314C to include visual indication of action 334N associated with icon 332N. Visual indication of action 334N may include an animation of a graphical element with a shape that suggests or is indicative of functionality of an action mapped to icon 332N. For example, UID 304 may display GUI 314C to include visual indication of action 334N as an animation of outputting a graphical element that has the shape of an expanded or highlighted version of the graphical element included in icon 332N. UID 304 may display GUI 314C such that graphical elements other than visual indication of action 334N are blurred in order to highlight a multimodal input state associated with visual indication of action 334N.

Computing device 302 may receive an indication of a first user input at location 320C of GUI 314C. Computing device 302 may receive an indication of a second user input at a location of GUI 314C that is not near or at location 320C. For example, computing device 302 may receive an indication of a second user input as a swipe tactile input away from location 320C (e.g., a swipe input along path 322A). Responsive to receiving the indication of the second user input, computing device 302 may output data for GUI 314B. Computing device 302 may output, via UID 304, data for GUI 314B in a way that replaces GUI 314C. Computing device 302 may output data for GUI 314B as a window that overlays GUI 314A.

Computing device 302 may receive an indication of a third user input provided at a location of GUI 314B associated with an icon of icons 332. In the example of FIG. 3, computing device 302 may receive an indication of a third user input provided at location 320D of GUI 314B associated with icon 332A. Responsive to receiving the indication of the third user input, computing device 302 may output data for GUI 314D associated with an input graphical user interface for icon 332A. Computing device 302 may output, via UID 304, data for GUI 314D that includes visual indication of action 334A. Visual indication of action 334A may include an animation of a graphical element with a shape that suggests the functionality of an action mapped to icon 332A. In some instances, responsive to computing device 302 determining the third user input terminates at location 320E of GUI 314D, computing device 302 may initiate an action mapped to icon 332A.

In the example of FIG. 3, computing device 302 may receive an indication of a fourth user input at a location that is not at or near location 320E. For example, computing device 302 may receive an indication of a fourth user input as a swipe tactile input away from location 320E (e.g., a swipe input along path 322B). In some instances, computing device 302 may receive the indication of the fourth user input at a location of GUI 314D that is not at or near location 320E. In some examples, computing device 302 may receive the indication of the fourth user input at location 320F of GUI 314A. For example, in instances where GUI 314D is displayed as a window that overlays GUI 314A, computing device 302 may determine the indication of the fourth user input is located at location 320F. Location 320F may, for example, be associated with an invocation zone, such as a virtual home button or navigation handle bar. In response to receiving the indication of the fourth user input at location 320F. Computing device 302 may output, for display at UID 304, data for GUI 314A. Additionally or alternatively, computing device 302 may remove, responsive to receiving the indication of the fourth user input, GUI 314D from display at UID 304.

In some examples, the first user input, the second user input, the third user input, and the fourth user input as described in FIG. 3 may be part of a single, continuous user input. That is, computing device 302 may output GUIs 314 based on determined locations of a single, gestural user input. In this way, computing device 302 may allow a user to seamlessly switch between multimodal input actions via GUIs 314B-314D via a single user input.

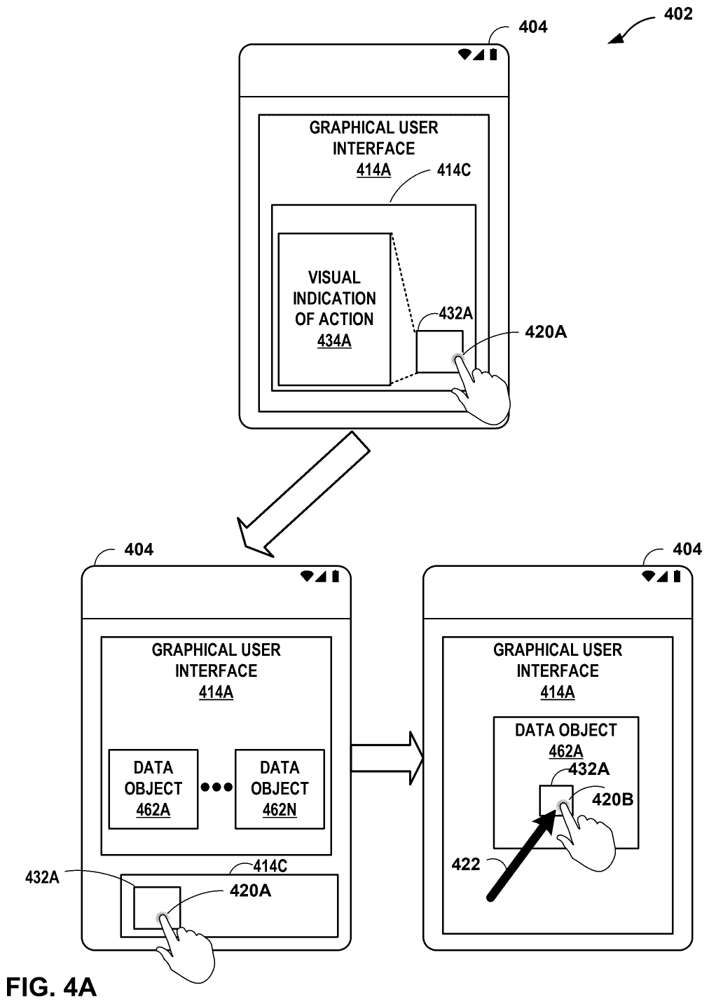

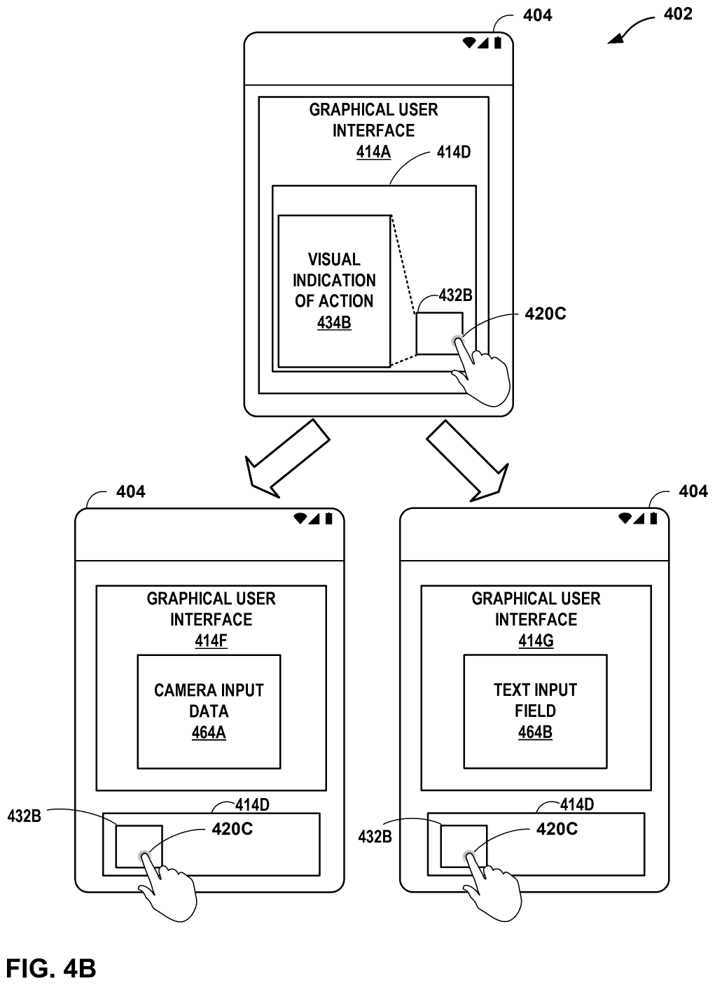

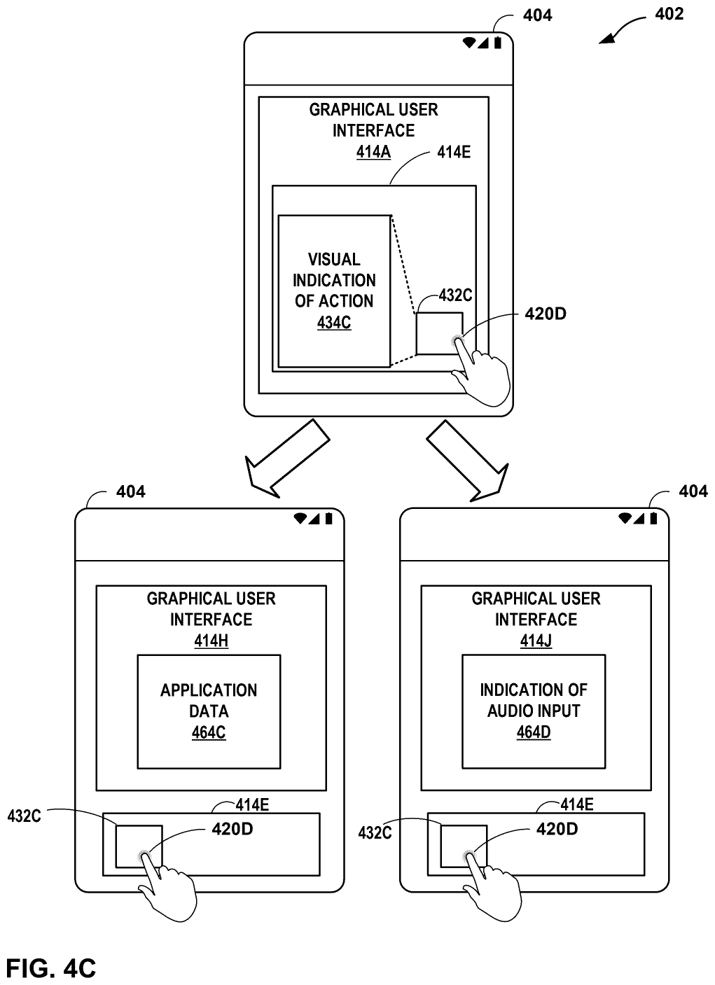

FIG. 4A-4C are conceptual diagrams illustrating example computing device 402 configured to initiate actions, in accordance with aspects of this disclosure. Computing device 402, GUIs 414A-414E, and icons 432 of FIG. 4A-4C may be an example or alternative implementations of computing device 102, GUIs 114, and icons 132 of FIG. 1, respectively.

In the example of FIG. 4A, computing device 402 may output, for display at UID 404, GUI 414C as an input state graphical user interface associated with icon 432A. Computing device 402 may display GUI 414C as a window overlayed on GUI 114A, where GUI 114A is a zero state graphical user interface displayed via UID 404 during operation of computing device 402. GUI 414C may include data associated with icon 432A and visual indication of action 434A. Visual indication of action 434A may include a graphical element with a shape and/or animation that indicates or suggests functionality of a multimodal input action associated with icon 432A.

In response to computing device 402 determining a user input terminates at location 420A of GUI 414C, computing device 402 may initiate an action associated with prompting a user to input a data object of GUI 414A. While the user input is detected at location 420A of GUI 414C, computing device 402 may recognize data objects 462A-462N (collectively referred to as “data objects 462”) of GUI 414A. Data objects 462 may represent elements, structures, and/or components of GUI 414A that define content, behavior, and layout of GUI 414A. For example, data objects 462 may represent graphic objects (e.g., images, icons, shapes, etc.) included in GUI 414A, widgets (e.g., buttons, text fields, check boxes, menus, sliders, etc.), containers (e.g., windows, tabs, etc.), or the like. Computing device 402 may recognize data objects 462 using machine learning techniques (e.g., neural networks) to recognize data objects 462 within an image or video stream displayed at GUI 414A. In some instances, computing device 402 may analyze an element hierarchy of GUI 414A to identify data objects 462 displayed as part of GUI 414A.

Computing device 402 may prompt a user operating computing device 402 to select one of data objects 462. For example, computing device 402 may prompt a user by highlighting data objects 462 within GUI 414 (e.g., darken or blur backgrounds around identified data objects 462). Computing device 402 may receive a user input along path 422 and at location 420B indicating a user selecting data object 462A. In some examples, computing device 402 may output an animation of the user input as dragging icon 432A on top of data object 462A in GUI 414A.

In response to determining the user input terminates at or near location 420B, computing device 402 may initiate the action associated with icon 432A. For example, icon 432A may be mapped to an action of performing a search based on a selected object (e.g., data object 462A of FIG. 4A). Computing device 402 may perform a search by inputting data object 462A into a search engine configured to output search results. In some examples, computing device 402 may input data object 462A into a machine learning model trained to generate and output content (e.g., search results, descriptions, etc.) based on multimodal data that may be included in any of data objects 462.

In the example of FIG. 4B, computing device 402 may output, for display at UID 404, data for GUI 414D as an input state graphical user interface associated with icon 432B. Computing device 402 may display GUI 414D as a window overlayed on GUI 114A, where GUI 114A is a zero state graphical user interface displayed via UID 404 during operation of computing device 402. GUI 414D may include icon 432B and visual indication of action 434B. Visual indication of action 434B may include a graphical element with a shape and/or animation that indicates or suggest functionality of a multimodal input action associated with icon 432B. In response to computing device 402 determining a user input terminates at location 420C of GUI 414D, computing device 402 may initiate an action associated with prompting a user to input multimodal data based on a mapping of icon 432B to the action.

In one example illustrated in FIG. 4B, icon 432B may be mapped to an action associated with camera functionality provided by computing device 402. For example, in response to computing device 402 determining a user input terminates at location 420C of GUI 414D, computing device 402 may output, for display at UID 404, GUI 414F as a camera interface. GUI 414F may include data for a camera interface that displays camera input data 464A. Camera input data 464A may include image and/or video data captured using a camera and/or microphone of computing device 402. Computing device 402 may save or otherwise store an instance of camera input data 464A based on a user input indicating an image or video capture using the camera and/or microphone of computing device 402. In some instances, computing device 402 may process camera input data 464A to identify data objects included in camera input data 464A. For example, computing device 402 may identify data objects of camera input data 464A using machine learning techniques (e.g., neural networks) to identify outlines of subjects or items captured as camera input data with a camera of computing device 402. Computing device 402 may prompt a user to select an identified data object of camera input data 464A. Computing device 402 may input a selected data object of camera input data 464A to a search engine configured to output search results based on the selected data object. In some instances, computing device 402 may input a selected data object of camera input data 464A into a machine learning model trained to generate and output a response (e.g., search results, descriptions, etc.) based on the selected data object.

In another example illustrated in FIG. 4B, icon 432B may be mapped to an action associated with prompting a user to input text data. For example, in response to computing device 402 determining a user input terminates at location 420C of GUI 414D, computing device 402 may output, for display at UID 404, GUI 414G as a text box. GUI 414G may include a text box associated with search or other functionality provided by computing device 402. GUI 414G may include text input field 464B. Text input field 464B may include a field in which a user operating computing device 402 may input text (e.g., character data).

Computing device 402 may save or otherwise store user inputs provided at text input field 464B. In some instances, computing device 402 may input text data provided at text input field 464B into a machine learning model trained to generate a response (e.g., search results, an answer to a question or request, etc.) based on the input text data included in text input field 464B.

In the example of FIG. 4C, computing device 402 may output, for display at UID 404, GUI 414E as an input state graphical user interface associated with icon 432C. Computing device 402 may display GUI 414E as a window overlayed on GUI 114A, where GUI 114A is a zero state graphical user interface displayed via UID 404 during operation of computing device 402. GUI 414E may include data associated with icon 432C and visual indication of action 434C. Visual indication of action 434C may include a graphical element with a shape and/or animation that indicates or suggests functionality of a multimodal input action associated with icon 432C.

In response to computing device 402 determining a user input terminates at location 420D of GUI 414E, computing device 402 may initiate an action mapped to icon 432C. In one example illustrated in FIG. 4C, icon 432C may be mapped to an action associated with a software application of computing device 402 (e.g., applications 254 of FIG. 2). For example, responsive to determining a user input terminates at location 420D of GUI 414E, computing device 402 may output, for display at UID 404, GUI 414H as a graphical user interface associated with a software application. GUI 414H may include application data 464C. Application data 464C may include data associated with input multimodal data during execution of the software application. For example, in instances where the software application is a messaging application, GUI 414H may include a user interface for the messaging application and application data 464C may include input messaging data (e.g., conversation threads, images, etc.). In some examples, application data 464C may include a prompt for a user to input different types of multimodal data associated with a software application. For instance, application data 464C may include a prompt for a user to input an image using a camera of computing device 404 in instances where GUI 414H is associated with a social media application.

In another example illustrated in FIG. 4C, icon 432C may be mapped to an action associated with prompting a user to input audio data. For example, responsive to computing device 402 determining a user input terminates at location 420D of GUI 414E, computing device 402 may output, for display at UID 404, GUI 414J as an audio input interface. GUI 414J may include an audio input interface that includes indication of audio input 464D. Indication of audio input 464D may include animations associated with audio input detected by a microphone of computing device 402. For example, indication of audio input 464D may include an animation of an audio waveform associated with audio detected by a microphone of computing device 402. Computing device 402 may save or otherwise store audio inputs provided during user interaction with GUI 414J. In some instances, computing device 402 may process input audio provided during user interactions with GUI 414J. For example, computing device 402 may process input audio during interactions GUI 414J by performing speech to text operations based on the input audio, inputting the input audio into a machine learning model trained to generate and output responses (e.g., a search result, a response to a question, etc.) based on audio inputs, or the like.

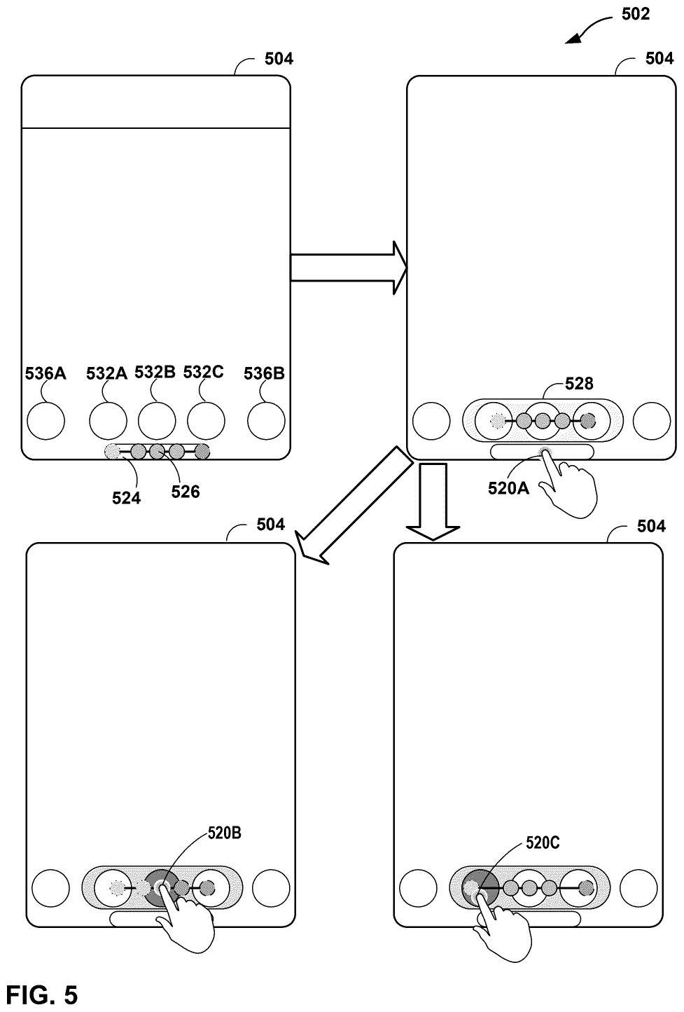

FIG. 5 is a conceptual diagram illustrating example computing device 502 with example graphical user interface locations 520, in accordance with aspects of this disclosure. Computing device 502, UID 504, and locations 520 may example or alternative implementations of computing device 102, UID 104, and locations 120 of FIG. 1, respectively.

In the example of FIG. 5, computing device 502 may display, via UID 504, an invocation zone 524. Invocation zone 524 may include an omnipresent graphical element (e.g., virtual home screen button, oval, circle, etc.) that is displayed during operation of computing device 502. Computing device 502 may include input selector zones 526. Input selector zones 526 may include zones configured to detect user inputs to perform the techniques described herein. For example, input selector zones 526 may include a linear array of zones that define indications of user inputs representing user inputs at any of locations 520.

In some examples, UID 504 may include configurable zones 536A-536B (collectively referred to herein as “configurable zones 536”). Configurable zone 536 may include a zone of UID 504 that a user may configure to be a part of input selector zones 526. For example, computing device 502 may allow a user to select an icon and corresponding action to be associated with configurable zone 536A. Computing device 502 may adjust input selector zones 526 to include an additional touch zone associated with configural zone 536A. That is, computing device 502 may extend input selector zones 526 to include the area of UID 504 associated with configurable zone 536A in response to a user configuring configurable zone 536A with an icon-action pair, in accordance with the techniques described herein.

When no user input is detected, input selector zones 526 may be positioned at invocation zone 524. In response to receiving a user input at location 520A associated with invocation zone 524, computing device 502 may shift input selector zones 526 to be positioned across each of icons 532. While the user input is still determined to be at location 520A, input selector zones 526 may be configured such that an ambiguous user input between icon 532A and 532C results in an indication of a user input associated with selecting icon 532B.

Responsive to computing device 502 receiving a user input at location 520B, computing device 502 may determine the user input corresponds to an indication of a user input associated with icon 532B. While the user input is still determined to be at or near location 520B, computing device 502 may adjust input selector zone 526 such that an ambiguous user input between icon 532B and 532A results in an indication of a user input associated with selecting icon 532A. Similarly, while the user input is still determined to be at or near location 520B, computing device 502 may adjust input selector zones 526 such that an ambiguous user input between icon 532B and 532C results in an indication of a user input associated with selecting icon 532C.

Responsive to computing device 502 receiving a user input at location 520C, computing device 502 may determine the user input corresponds to an indication of a user input associated with icon 532A. While the user input is still determined to be at or near location 520C, input selector zone 526 may be configured such that ambiguous inputs between icon 532A and icon 532C result in an indication of a user input associated with selecting icon 532B. By computing device 502 adjusting input selector zones 526 based on locations 520, computing device 502 may allow a user to switch between multimodal input actions associated with icons 532 with a single, continuous user input. For example, by shifting biases associated with ambiguous user inputs based on a current location of a user input, computing device 502 may seamlessly display indications of multimodal input actions associated with icons 532.

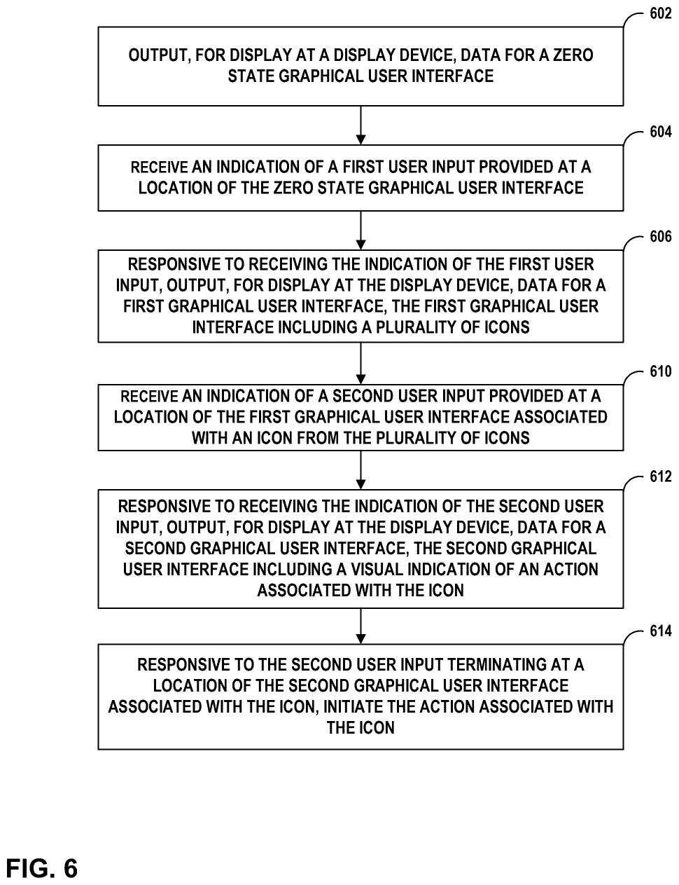

FIG. 6 is a flowchart illustrating example operations for switching between initiations of actions associated with multimodal inputs, in accordance with one or more aspects of the present disclosure. FIG. 6 may be discussed with respect to FIG. 1 for example purposes only.

Computing device 102 may output, for display at UID 104, data for a zero state graphical user interface (602). For example, computing device 102 may display, via UID 104, GUI 114A associated with a graphical user interface displayed during operation of computing device 102. Computing device 102 may receive an indication of a first user input provided at a location of the zero state graphical user interface (604). For example, computing device 102 may receive an indication of a first user input at location 120A, which may be associated with an invocation point included in GUI 114A (e.g., a navigation bar, a home button, etc.).

Responsive to receiving the indication of the first user input, computing device 102 may output, for display at UID 104, data for a first graphical user interface, the first graphical user interface including a plurality of icons (606). For example, in response to receiving the indication of the first user input provided at location 120A of GUI 114A, computing device 102 may output, for display at UID 104, data for GUI 114B that includes icons 132. Each of icons 132 may be mapped to a particular multimodal input action or multimodal input state associated with prompting a user to input one or more modes of data.

Computing device 102 may receive an indication of a second user input provided at a location of the first graphical user interface associated with an icon from the plurality of icons (610). For example, computing device 102 may receive an indication of a second user input provided at location 120B of GUI 114B that is associated with icon 132N. Responsive to receiving the indication of the second user input, computing device 102 may output, for display at UID 104, data for a second graphical user interface, the second graphical user interface including a visual indication of an action associated with the icon (612). For example, in response to computing device 102 receiving a user input at location 120B of GUI 114B, computing device 102 may output, for display at UID 104, data for GUI 114C that includes visual indication of action 134. Visual indication of action 134, in the example of FIG. 1, may include a graphical element that has a shape and/or animation that suggests or is indicative of an action mapped to selected icon 132N.

Responsive to the second user input terminating at a location of the second graphical user interface associated with the icon, computing device 102 may initiate the action associated with the icon (614). For example, responsive to computing device 102 determining a user input terminates at location 120C of GUI 114C, computing device 102 may initiate an action mapped to selected icon 132N, in the example of FIG. 1. Computing device 102 may initiate an action such as one of: recognizing data objects displayed in the zero state graphical user interface, receiving an audio input, receiving an image input, receiving a text input, or executing a software application.

This disclosure includes the following examples:

Example 1: A method includes outputting, by one or more processors and for display at a display device, data for a zero state graphical user interface; receiving, by the one or more processors, an indication of a first user input provided at a location of the zero state graphical user interface; responsive to receiving the indication of the first user input, outputting, by the one or more processors and for display at the display device, data for a first graphical user interface, the first graphical user interface including a plurality of icons; receiving, by the one or more processors, an indication of a second user input provided at a location of the first graphical user interface associated with an icon from the plurality of icons; responsive to receiving the indication of the second user input, outputting, by the one or more processors and for display at the display device, data for a second graphical user interface, the second graphical user interface including a visual indication of an action associated with the icon; and responsive to the second user input terminating at a location of the second graphical user interface associated with the icon, initiating, by the one or more processors, the action associated with the icon.

Example 2: The method of example 1, wherein the first user input and the second user input are each part of a single, continuous user input.

Example 3: The method of any of examples 1 and 2, wherein the action associated with the icon includes one of: recognizing data objects displayed in the zero state graphical user interface, receiving an audio input, receiving an image input, receiving a text input, or executing a software application.

Example 4: The method of any of examples 1 through 3, wherein the zero state graphical user interface includes data for a user interface displayed at the display device at a point in time prior to receiving the indication of the first user input.

Example 5: The method of any of examples 1 through 4, wherein the visual indication of the action associated with the icon includes an animation of a graphical element that suggests functionality of the action.

Example 6: The method of any of examples 1 through 5, wherein the location of the second graphical user interface is a first location of the second graphical user interface, and wherein outputting the data for the second graphical user interface comprises: receiving an indication of a third user input provided at a second location of the second graphical user interface, wherein the second user input and the third user input are each parts of a single continuous user input; and responsive to receiving the indication of the third user input, outputting, for display at the display device, data for the first graphical user interface.

Example 7: The method of example 6, wherein the icon is a first icon, the visual indication is a first visual indication, the action is a first action, the location of the first graphical user interface is a first location of the first graphical user interface, and wherein the method further comprises: receiving an indication of a fourth user input provided at a second location of the first graphical user interface associated with a second icon from the plurality of icons, wherein the second user input, the third user input, and the fourth user input are each parts of the single continuous user input; responsive to receiving the indication of the fourth user input, outputting, for display at the display device, data for a third graphical user interface, the third graphical user interface including a second visual indication of a second action associated with the second icon; and responsive to the fourth user input terminating at a location of the third graphical user interface, initiating the second action associated with the second icon.

Example 8: The method of any of examples 1 through 7, wherein the location of the second graphical user interface is a first location of the second graphical user interface, and wherein outputting the data for the second graphical user interface comprises: receiving an indication of a third user input provided at a second location of the second graphical user interface, wherein the second user input and the third user input are each parts of a single continuous user input; and responsive to receiving the indication of the third user input, outputting, for display at the display device, data for the zero state graphical user interface.

Example 9: The method of any of examples 1 through 8, wherein the first user input includes at least one of: a long-press tactile input, a swipe-up tactile input, or a press tactile input provided at the location of the zero state graphical user interface.

Example 10: The method of any of examples 1 through 9, wherein the first user input and the second user input correspond to motion inputs detected using the display device.

Example 11: A device includes at least one processor; a display device; and a storage device that stores instructions executable by the at least one processor to: output, for display at the display device, data for a zero state graphical user interface; receive an indication of a first user input provided at a location of the zero state graphical user interface; responsive to receiving the indication of the first user input, output, for display at the display device, data for a first graphical user interface, the first graphical user interface including a plurality of icons; receive an indication of a second user input provided at a location of the first graphical user interface associated with an icon from the plurality of icons; responsive to receiving the indication of the second user input, output, for display at the display device, data for a second graphical user interface, the second graphical user interface including a visual indication of an action associated with the icon; and responsive to the second user input terminating at a location of the second graphical user interface associated with the icon, initiate the action associated with the icon.

Example 12: The device of example 11, wherein the first user input and the second user input are each part of a single, continuous user input.

Example 13: The device of any of examples 11 and 12, wherein to initiate the action associated with the icon, the storage device stores instructions executable by the at least one processor to: recognize data objects displayed in the zero state graphical user interface, receive an audio input, receive an image input, receive a text input, or execute a software application.

Example 14: The device of any of examples 11 through 13, wherein the zero state graphical user interface includes data for a user interface displayed at the display device at a point in time prior to receiving the indication of the first user input.

Example 15: The device of any of examples 11 through 14, wherein the visual indication of the action associated with the icon includes an animation of a graphical element that suggests functionality of the action.

Example 16: The device of any of examples 11 through 15, wherein the location of the second graphical user interface is a first location of the second graphical user interface, and wherein to output the data for the second graphical user interface, the storage device stores instructions executable by the at least one processor to: receive an indication of a third user input provided at a second location of the second graphical user interface, wherein the second user input and the third user input are each parts of a single continuous user input; and responsive to receiving the indication of the third user input, output, for display at the display device, data for the first graphical user interface.

Example 17: The device of example 16, wherein the icon is a first icon, the visual indication is a first visual indication, the action is a first action, the location of the first graphical user interface is a first location of the first graphical user interface, and wherein the storage device further stores instructions executable by the at least one processor to: receive an indication of a fourth user input provided at a second location of the first graphical user interface associated with a second icon from the plurality of icons, wherein the second user input, the third user input, and the fourth user input are each parts of the single continuous user input; responsive to receiving the indication of the fourth user input, output, for display at the display device, data for a third graphical user interface, the third graphical user interface including a second visual indication of a second action associated with the second icon; and responsive to the fourth user input terminating at a location of the third graphical user interface, initiate the second action associated with the second icon.

Example 18: The device of any of examples 11 through 17, wherein the location of the second graphical user interface is a first location of the second graphical user interface, and wherein to output the data for the second graphical user interface, the storage device stores instructions executable by the at least one processor to: receive an indication of a third user input provided at a second location of the second graphical user interface, wherein the second user input and the third user input are each parts of a single continuous user input; and responsive to receiving the indication of the third user input, output, for display at the display device, data for the zero state graphical user interface.

Example 19: The device of any of examples 11 through 18, wherein the first user input includes at least one of: a long-press tactile input, a swipe-up tactile input, or a press tactile input provided at the location of the zero state graphical user interface.

Example 20: The device of any of examples 11 through 19, wherein the first user input and the second user input correspond to motion inputs detected using the display device.

Example 21: Computer-readable storage media storing instructions that, when executed, cause at least one processor of a computing device to: output, for display at a display device, data for a zero state graphical user interface; receive an indication of a first user input provided at a location of the zero state graphical user interface; responsive to receiving the indication of the first user input, output, for display at the display device, data for a first graphical user interface, the first graphical user interface including a plurality of icons; receive an indication of a second user input provided at a location of the first graphical user interface associated with an icon from the plurality of icons; responsive to receiving the indication of the second user input, output, for display at the display device, data for a second graphical user interface, the second graphical user interface including a visual indication of an action associated with the icon; and responsive to the second user input terminating at a location of the second graphical user interface associated with the icon, initiate the action associated with the icon.

Example 22: The computer-readable storage media of example 21, wherein the first user input and the second user input are each part of a single, continuous user input.

Example 23: The computer-readable storage media of any of examples 21 and 22, wherein to initiate the action associated with the icon, the instructions cause the at least one processor of the computing device to: recognize data objects displayed in the zero state graphical user interface, receive an audio input, receive an image input, receive a text input, or execute a software application.

Example 24: The computer-readable storage media of any of examples 21 through 23, wherein the zero state graphical user interface includes data for a user interface displayed at the display device at a point in time prior to receiving the indication of the first user input.

Example 25: The computer-readable storage media of any of examples 21 through 24, wherein the visual indication of the action associated with the icon includes an animation of a graphical element that suggests functionality of the action.

Example 26: The computer-readable storage media of any of examples 21 through 25, wherein the location of the second graphical user interface is a first location of the second graphical user interface, and wherein to output the data for the second graphical user interface, the instructions cause the at least one processor of the computing device to: receive an indication of a third user input provided at a second location of the second graphical user interface, wherein the second user input and the third user input are each parts of a single continuous user input; and responsive to receiving the indication of the third user input, output, for display at the display device, data for the first graphical user interface.

Example 27: The computer-readable storage media of example 26, wherein the icon is a first icon, the visual indication is a first visual indication, the action is a first action, the location of the first graphical user interface is a first location of the first graphical user interface, and wherein the instructions further cause the at least one processor of the computing device to: receive an indication of a fourth user input provided at a second location of the first graphical user interface associated with a second icon from the plurality of icons, wherein the second user input, the third user input, and the fourth user input are each parts of the single continuous user input; responsive to receiving the indication of the fourth user input, output, for display at the display device, data for a third graphical user interface, the third graphical user interface including a second visual indication of a second action associated with the second icon; and responsive to the fourth user input terminating at a location of the third graphical user interface, initiate the second action associated with the second icon.

Example 28: The computer-readable storage media of any of examples 21 through 27, wherein the location of the second graphical user interface is a first location of the second graphical user interface, and wherein to output the data for the second graphical user interface, the instructions cause the at least one processor of the computing device to: receive an indication of a third user input provided at a second location of the second graphical user interface, wherein the second user input and the third user input are each parts of a single continuous user input; and responsive to receiving the indication of the third user input, output, for display at the display device, data for the zero state graphical user interface.

Example 29: The computer-readable storage media of any of examples 21 through 28, wherein the first user input includes at least one of: a long-press tactile input, a swipe-up tactile input, or a press tactile input provided at the location of the zero state graphical user interface.

Example 30: The computer-readable storage media of any of examples 21 through 29, wherein the first user input and the second user input correspond to motion inputs detected using the display device.

Example 31: A computing system comprising means for performing any combination of examples 1-30.

Example 32: A computing device comprising means for performing any combination of examples 1-30.

Example 33: A non-transitory computer-readable storage medium encoded with instructions that, when executed by one or more processors, cause the one or more processors to perform any combination of examples 1-30.

Example 34: A computer program product comprising at least one non-transitory computer-readable medium including one or more instructions that, when executed by at least one processor, cause the at least one processor to perform any combination of examples 1-30.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

In some implementations, a user may be provided with controls allowing the user to make an election as to both if and when the systems, programs, or features described herein may enable collection or use of user information. Such user information may include, for example, content displayed on a screen, camera or microphone data, text inputs, or motion data. The described techniques may be implemented only in instances where a user provides consent for such collection or use. Furthermore, certain data may be processed in one or more ways before it is stored or used, so that personally identifiable information is removed. For example, a user's identity may be disassociated from the collected data, or screen content may be processed ephemerally to extract object data without storing the underlying screen image. In this way, the user may have control over what information is collected, how that information is used, and what information is provided, ensuring that the features are implemented in a privacy-preserving manner.

Various examples of the disclosure have been described. Any combination of the described systems, operations, or functions is contemplated. These and other examples are within the scope of the following claims.

What is claimed is:

1. A method comprising:
outputting, by one or more processors and for display at a display device, data for a zero state graphical user interface;
receiving, by the one or more processors, an indication of a first user input provided at a location of the zero state graphical user interface;
responsive to receiving the indication of the first user input, outputting, by the one or more processors and for display at the display device, data for a first graphical user interface, the first graphical user interface including a plurality of icons;
receiving, by the one or more processors, an indication of a second user input provided at a location of the first graphical user interface associated with an icon from the plurality of icons;
responsive to receiving the indication of the second user input, outputting, by the one or more processors and for display at the display device, data for a second graphical user interface, the second graphical user interface including a visual indication of an action associated with the icon; and
responsive to the second user input terminating at a location of the second graphical user interface associated with the icon, initiating, by the one or more processors, the action associated with the icon.

2. The method of claim 1, wherein the first user input and the second user input are each part of a single, continuous user input.

3. The method of claim 1, wherein the action associated with the icon includes one of:
recognizing data objects displayed in the zero state graphical user interface,
receiving an audio input,
receiving an image input,
receiving a text input, or
executing a software application.

4. The method of claim 1, wherein the zero state graphical user interface includes data for a user interface displayed at the display device at a point in time prior to receiving the indication of the first user input.

5. The method of claim 1, wherein the visual indication of the action associated with the icon includes an animation of a graphical element that suggests functionality of the action.

6. The method of claim 1, wherein the location of the second graphical user interface is a first location of the second graphical user interface, and wherein outputting the data for the second graphical user interface comprises:
receiving an indication of a third user input provided at a second location of the second graphical user interface, wherein the second user input and the third user input are each parts of a single continuous user input; and
responsive to receiving the indication of the third user input, outputting, for display at the display device, data for the first graphical user interface.

7. The method of claim 6, wherein the icon is a first icon, the visual indication is a first visual indication, the action is a first action, the location of the first graphical user interface is a first location of the first graphical user interface, and wherein the method further comprises:
receiving an indication of a fourth user input provided at a second location of the first graphical user interface associated with a second icon from the plurality of icons, wherein the second user input, the third user input, and the fourth user input are each parts of the single continuous user input;
responsive to receiving the indication of the fourth user input, outputting, for display at the display device, data for a third graphical user interface, the third graphical user interface including a second visual indication of a second action associated with the second icon; and
responsive to the fourth user input terminating at a location of the third graphical user interface, initiating the second action associated with the second icon.

8. The method of claim 1, wherein the location of the second graphical user interface is a first location of the second graphical user interface, and wherein outputting the data for the second graphical user interface comprises:
receiving an indication of a third user input provided at a second location of the second graphical user interface, wherein the second user input and the third user input are each parts of a single continuous user input; and
responsive to receiving the indication of the third user input, outputting, for display at the display device, data for the zero state graphical user interface.

9. The method of claim 1, wherein the first user input includes at least one of: a long-press tactile input, a swipe-up tactile input, or a press tactile input provided at the location of the zero state graphical user interface.

10. The method of claim 1, wherein the first user input and the second user input correspond to motion inputs detected using the display device.

11. A device comprising:
at least one processor;
a display device; and
a storage device that stores instructions executable by the at least one processor to:
output, for display at the display device, data for a zero state graphical user interface;
receive an indication of a first user input provided at a location of the zero state graphical user interface;
responsive to receiving the indication of the first user input, output, for display at the display device, data for a first graphical user interface, the first graphical user interface including a plurality of icons;
receive an indication of a second user input provided at a location of the first graphical user interface associated with an icon from the plurality of icons;
responsive to receiving the indication of the second user input, output, for display at the display device, data for a second graphical user interface, the second graphical user interface including a visual indication of an action associated with the icon; and
responsive to the second user input terminating at a location of the second graphical user interface associated with the icon, initiate the action associated with the icon.

12. The device of claim 11, wherein the first user input and the second user input are each part of a single, continuous user input.

13. The device of claim 11, wherein to initiate the action associated with the icon, the storage device stores instructions executable by the at least one processor to:
recognize data objects displayed in the zero state graphical user interface,
receive an audio input,
receive an image input,
receive a text input, or
execute a software application.

14. The device of claim 11, wherein the location of the second graphical user interface is a first location of the second graphical user interface, and wherein to output the data for the second graphical user interface, the storage device stores instructions executable by the at least one processor to:
receive an indication of a third user input provided at a second location of the second graphical user interface, wherein the second user input and the third user input are each parts of a single continuous user input; and
responsive to receiving the indication of the third user input, output, for display at the display device, data for the first graphical user interface.

15. The device of claim 14, wherein the icon is a first icon, the visual indication is a first visual indication, the action is a first action, the location of the first graphical user interface is a first location of the first graphical user interface, and wherein the storage device further stores instructions executable by the at least one processor to:
receive an indication of a fourth user input provided at a second location of the first graphical user interface associated with a second icon from the plurality of icons, wherein the second user input, the third user input, and the fourth user input are each parts of the single continuous user input;
responsive to receiving the indication of the fourth user input, output, for display at the display device, data for a third graphical user interface, the third graphical user interface including a second visual indication of a second action associated with the second icon; and
responsive to the fourth user input terminating at a location of the third graphical user interface, initiate the second action associated with the second icon.

16. The device of claim 11, wherein the location of the second graphical user interface is a first location of the second graphical user interface, and wherein to output the data for the second graphical user interface, the storage device stores instructions executable by the at least one processor to:
receive an indication of a third user input provided at a second location of the second graphical user interface, wherein the second user input and the third user input are each parts of a single continuous user input; and
responsive to receiving the indication of the third user input, output, for display at the display device, data for the zero state graphical user interface.

17. Non-transitory computer-readable storage media storing instructions that, when executed, cause at least one processor of a computing device to:
output, for display at a display device, data for a zero state graphical user interface;
receive an indication of a first user input provided at a location of the zero state graphical user interface;
responsive to receiving the indication of the first user input, output, for display at the display device, data for a first graphical user interface, the first graphical user interface including a plurality of icons;
receive an indication of a second user input provided at a location of the first graphical user interface associated with an icon from the plurality of icons;
responsive to receiving the indication of the second user input, output, for display at the display device, data for a second graphical user interface, the second graphical user interface including a visual indication of an action associated with the icon; and
responsive to the second user input terminating at a location of the second graphical user interface associated with the icon, initiate the action associated with the icon.

18. The non-transitory computer-readable storage media of claim 17, wherein the first user input and the second user input are each part of a single, continuous user input.

19. The non-transitory computer-readable storage media of claim 17, wherein to initiate the action associated with the icon, the instructions cause the at least one processor of the computing device to:
recognize data objects displayed in the zero state graphical user interface,
receive an audio input,
receive an image input,
receive a text input, or
execute a software application.

20. The non-transitory computer-readable storage media of claim 17, wherein the visual indication of the action associated with the icon includes an animation of a graphical element that suggests functionality of the action.
